(19) United States
(12) Patent Application Publication
(10) Pub. No.: US 2015/0166296 A1
(43) Pub. Date: Jun. 18, 2015

(54) FOLDED BOOKLET AND METHOD

(71) Applicant: Patricia A. Witkowski, Phoenix, MD (US)

(72) Inventor: Patricia A. Witkowski, Phoenix, MD (US)

(21) Appl. No.: 14/569,252

(22) Filed: Dec. 12, 2014

Related U.S. Application Data
(60) Provisional application No. 61/915,736, filed on Dec. 13, 2013.

(51) Int. Cl. B65H 45/24; B42D 5/00

(52) U.S. Cl. CPC B65H 45/24; B42D 5/00

(57) ABSTRACT

A fold-a-book and method for making same, comprising a 8-panel (16-page) booklet that can be folded or unfolded without the aid of staples, glue or the like to alternatively comprise the booklet and a poster spread that is eight times the size of the booklet. The method includes a method for placing and printing user-chosen images on the booklet while in its fully expanded state. Images printed on the booklet panels may be sized to fit in standard size photo frames. The recipient can choose to leave the booklet intact, or to remove the panels by cutting at the folds and inserting the panels into photo frames for display.

### CROSS-REFERENCE TO RELATED APPLICATION(S)

The present application derives priority from U.S. Provisional Patent Application No. 61/915,736 filed 13 Dec. 2013.

### BACKGROUND OF THE INVENTION

1. Field of the Invention

The present invention relates generally to folded paper products and a method for forming the same.

2. Description of the Background

Modern printing techniques allow for high-quality, color images and/or text to be printed on widely varying sizes and shapes of paper, poster stock, card stock, plastic film (synthetic) substrates or like material having various finishes. One common application of such printing technology is the creation of high-quality color posters, often printed on a large scale on a single sheet of glossy or poster-type paper. Modern printers, such as laser printers, are capable of printing such large-scale pictures of sufficient quality and resolution as to be appropriate for framing or display. However, when not in their fully expanded, display state, posters and large-scale printed images are often rolled-up to store or transport them. However, such means of transportation or storage does not allow a user to view the full image printed on the sheet until the sheet is fully unrolled. Further, the rolled sheet is not able to be reduced in size along one dimension, i.e. along the axis of the sheet that is perpendicular to the direction in which the sheet is rolled.

In addition, there exist a variety of techniques for folding sheets of printed information into flat and more compact formats for ease of handling. The most common is the accordion-type fold wherein a sheet of paper or like material containing a printed image is folded using parallel pleats along one axis of the sheet. Right angle folds may be added to allow tall formats to be compacted into even smaller folded dimensions. Maps are typically folded in this manner. The accordion fold is advantageous in that it allows for the sheet to be transported in a more compact form, and, depending on the folding pattern, may allow a user to view some aspects of the printed image without completely unfolding the sheet. However, all the pages of an accordion-folded booklet cannot be viewed without fully unfolding the booklet and this is inconvenient and unwieldy. Moreover, accordion-folded sheets are prone to coming unfolded by themselves. Therefore, the accordion-style fold limits the type and layout of text and images that may be printed on a sheet of paper that is folded in this style. Moreover, accordion-folded sheets do not paginate like a book, but rather open to a large spread. Consequently, accordion-folded booklets are seldom used as a substitute for bound books.

Traditional books and magazines are bound with stiches, staples and/or adhesive. Images and written content are printed on a sheet of paper, and that sheet is then folded into multi-page signatures and bound together using staples, glue, or the like for viewing in a single or double-page spread. A magazine-style binding can accommodate sheets of varying sizes containing images as large as the area of two pages of the magazine. Binding is expensive compared to folding techniques as described above. The cost of binding is less important for large production runs of thousands of the same publication. However, the fastest growing segment of the publishing industry demands one-offprint on demand publishing. Print on demand (POD) is a printing technology in which copies of a book (or other document) are not printed until an order has been received, which compels one-off production. Many traditional small presses have replaced their traditional printing equipment with POD equipment or contract their printing out to POD service providers. However, POD book binding equipment is expensive to purchase and operate.

What is needed is a means of conveying imagery and/or text on sheets of paper in a compact eight-panel (16-page) format with all the attributes of a bound booklet, but where a particular fold/cut pattern entirely eliminates the need for binding. A user is able to easily view the pages in booklet format, or if desired can still unfold the booklet to a large spread that covers the full surface area of the sheet. This would allow dual-use as a bound booklet with page-content derived entirely printing on one side of a larger sheet, or as a single-image poster or photo-collage with page-content derived entirely printing on the other side of the larger sheet.

The present invention is a fold-a-book, e.g., a folded booklet and method for producing an eight-panel 16-page booklet especially well-suited for the POD industry because it maintains all the advantages of a bound booklet without staples, glue, or like binding materials, thereby eliminating costly book binding equipment and materials, and drastically reducing production time and unit cost. A method of machine manufacturing an eight-panel 16-page booklet in accordance with the invention is also provided.

### SUMMARY OF THE INVENTION

In one aspect, the present invention comprises a method of cutting and folding a single sheet of paper into an eight panel four-double-sided-page “booklet” format whereby a plurality of individual images are printed on each panel for individual viewing. The method according to the present invention also results in a compact product that may be transported in flat packaging, that is sized to fit in various standard sizes of mailing envelopes, and that can be expanded upon receipt to a full poster-size sheet with an image that is potentially eight times larger than the original size of the booklet. Moreover, the method according to the present invention results in a booklet product containing panels which may be sized specifically to fit in standard size picture frames (such as 4×6 or 5×7), which are not marred by creases from folding over them or by staples or other means of binding. The recipient can choose to leave the booklet intact, or to remove the panels by cutting at the folds and inserting the panels into photo frames for display. The present invention further comprises an inexpensive method of conveying images and text in readable form without the need for staples or other binding elements. The present invention is also directed to the folded product that results from the method described herein.

The present invention is described in greater detail in the detailed description of the invention, and the appended drawings. Additional features and advantages of the invention will be set forth in the description that follows, will be apparent from the description, or may be learned by practicing the invention.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective view of the front of sheet 10 in accordance with an embodiment of the present invention.

FIG. 2 is a perspective view of the back of sheet 10 in accordance with an embodiment of the present invention.

FIG. 3 is a perspective view of the back of sheet 10 in accordance with an embodiment of the present invention.

FIG. 4 is a three-quarters perspective view of the front of sheet 10 to show cut 30 in accordance with an embodiment of the present invention.

FIG. 5 is a perspective view of sheet 10 in accordance with an embodiment of the present invention.

FIG. 6 is a perspective view of sheet 10 showing the method of folding along first crease 41 in accordance with an embodiment of the present invention.

FIG. 7 is a perspective view of sheet 10 in accordance with an embodiment of the present invention.

FIG. 8 is a perspective view of sheet 10 showing the method of folding along second crease 42 in accordance with an embodiment of the present invention.

FIG. 9 is a perspective view of sheet 10 in accordance with an embodiment of the present invention.

FIG. 10 is a perspective view of sheet 10 showing the method of folding along third crease 43 in accordance with an embodiment of the present invention.

FIG. 11 is a perspective view of sheet 10 in accordance with an embodiment of the present invention.

FIG. 12 is a perspective view of sheet 10 showing the method of folding along fourth crease 44 in accordance with an embodiment of the present invention.

FIG. 13 is a perspective view of sheet 10 showing the method of folding out the fourth crease 44 in accordance with an embodiment of the present invention.

FIG. 14 is a perspective view of sheet 10 showing the method of pinwheeling.

FIG. 15 is a three-quarters perspective view of fold-a-book 20 from the front in accordance with an embodiment of the present invention.

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

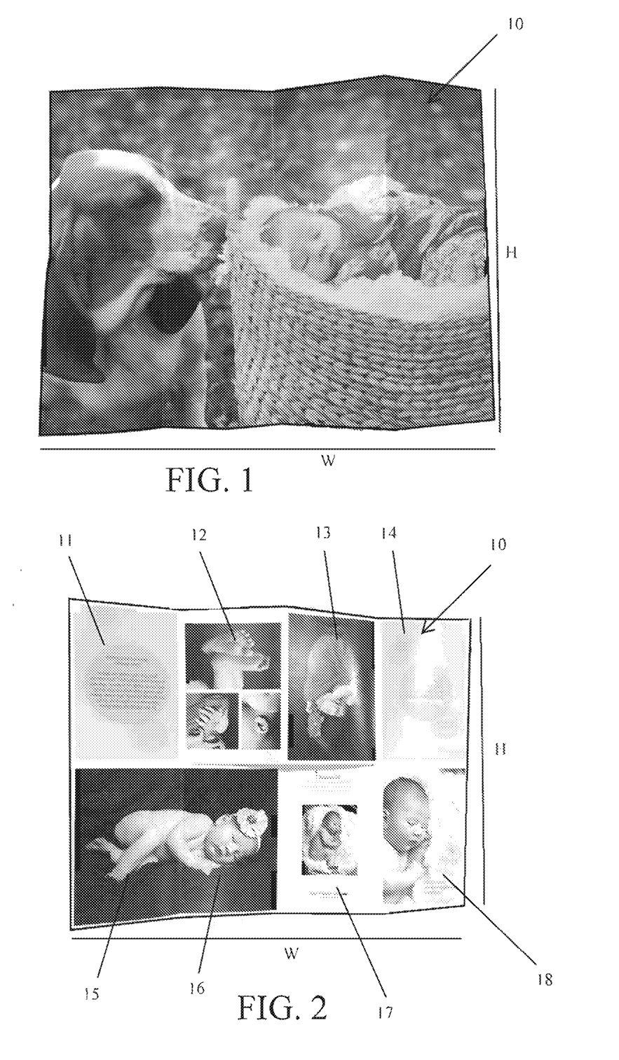

With reference to FIGS. 1, 2 and 3, the fold-a-book according to the present invention is shown in its fully open format. In the method according to the present invention, a rectangular sheet 10 of paper or like material in a predetermined size is printed with various images using a high quality digital printer, laser printer or the like. It will be understood by one skilled in the art that the overall size of the sheet 10 may be chosen as a design preference so that it may be sized to fit into a standard size picture or poster frame or other display means, or so that the relative sizes of images printed on individual panels of the sheet (as will be more fully described below) may fit into a standard size picture frame or other display means, or otherwise determined by design preference. The use of the term “paper” as used herein to describe the sheet 10 on which the images are printed is not intended to limit the scope of the current invention and the sheet 10 onto which images are printed may also comprise card stock, photo paper, glossy or poster paper, plastic film (synthetic) substrates, or any other material capable of maintaining some level of rigidity when folded. Moreover, it will be understood by one skilled in the art that the images, layout and content printed on the sheet 10 may be chosen by user preference, and may be printed using means other than a laser printer, such as inkjet printers, photo printers, traditional offset printing, web printing, letterpress, digital offset or dot matrix printers.

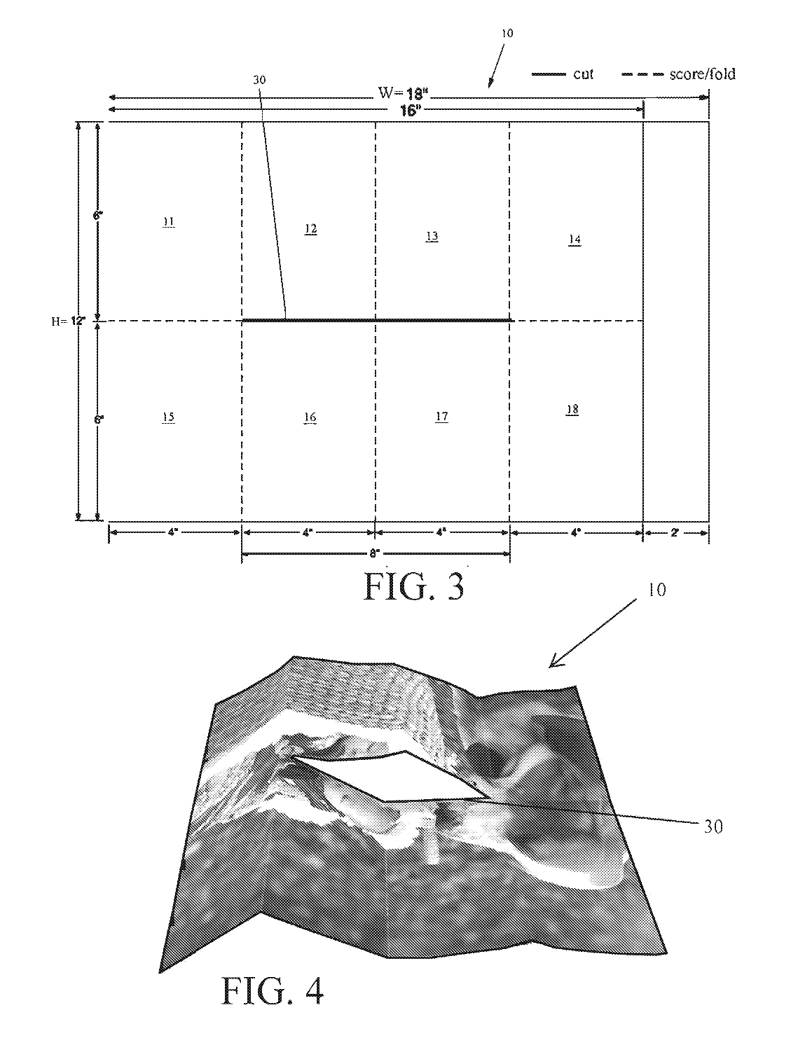

FIG. 1 depicts the front of the sheet 10 containing one large “poster-size” printed image for large format display, while FIGS. 2 and 3 depict the back of sheet 10. The terms “front” and “back” as used herein is not intended to limit the invention but is used merely to describe one arbitrarily chosen “side” of the virtually two-dimensional sheet 10 made of paper or like material. As can be seen with reference to FIGS. 2 and 3, sheet 10 is divided into eight (8) individual panels 11-18. Panels 11-18 have a height that is ½ the height of the full sheet 10, where the height of the full sheet 10 is denoted by the distance H in FIGS. 1, 2 and 3. Panels 11-18 have a width that is ¼ the width of the full sheet 10, where the width of the full sheet 10 is denoted by the distance W in FIGS. 1, 2 and 3. As stated above, the overall size (height and width) of sheet 10 is a matter of design preference, with the understanding that the height and width of the individual panels in sheet 10 are functions of the overall size based on the formula set forth above. In one preferred embodiment of the present invention, sheet 10 has a height H of 12 inches and a width W of 16 inches. Consequently, panels 11-18 each have a height of 6 inches and a width of 4 inches. These measurements allow sheet 10 to be printed on a standard-sized, 12×18 inch press sheet which has been trimmed down to a size of 12×16 by simply removing 2 inches from its width using a guillotine cutter or other device known in the art. The use of a standard-sized, readily available press sheet as sheet 10 simplifies production of the finished fold-a-book and lowers the cost of the materials used therein. The sizing according to the present embodiment also provides that individual panels 11-18 are sized to fit into standard 4×6 photo frames such that individual panels may be designated to be cut from the finished fold-a-book for display in such a frame, as set forth in more detail below. In another preferred embodiment, sheet 10 starts from a standard-sized sheet of 20.8125×29.5 inches. Using this paper size, the method according to the present invention results in individual panels that can fit into a standard 5×7 inch photo frame, and a fold-a-book product that can fit into a standard A-7 envelope. Similar efficiency and cost savings result from this embodiment as from the previous embodiment.

Panels 11-18 are oriented on sheet 10 as shown in FIG. 3, wherein panels 11-14 are formed by dividing sheet 10 into even quarters along its width on an upper half of sheet 10, and panels 15-18 are mirror images of panels 11-14 on the lower half of sheet 10, wherein the terms “upper half” and “lower half” are not intended to be limiting but are used for purposes of illustration, in that the upper half of sheet 10 is towards the top of the page in FIG. 3 and the lower half of sheet 10 is towards the bottom of the page in FIG. 3. Moreover, the description of the location of the panels and the description of certain panels as being “mirror images” of one another are not intended to be limiting with respect to the images that are printed on the sheet 10 or panels 11-18 as described below.

Although panels 11-18 are depicted in FIG. 2 as being delineated by folds or cuts in sheet 10, it will be understood to one having ordinary skill in the art that, for purposes of printing text or images on sheet 10, panels 11-18 may be represented in various ways through the use of computer software associated with the actual printing equipment. For example, computer software such as Adobe InDesign® can be programmed to contain an electronic template representing both the front and back of sheet 10 including panels 11-18 on the back of sheet 10. The template can be adjusted so that text or images to be printed on sheet 10 are resized and rotated or oriented within the template so that they will have the proper size and orientation when presented in the final folded product, fold-a-book 20, as shown in FIG. 15. With respect to sheet 10 as depicted in FIG. 3, the software can be programmed such that images inserted into panels 11-14 will be oriented “upside down”, so that the bottom of the image faces towards the top of sheet 10, and images inserted into panels 15-18 will be oriented “right side up”, so that the bottom of the images faces towards the bottom of sheet 10. In addition, the software can also contain a template for the front of sheet 10, which may be printed with one large image the same size as sheet 10 itself, oriented in any direction, or may alternatively be printed with multiple images based on user preference. Software programs and methods of programming them to achieve such templates are known to those having ordinary skill in the art. In this way, a user can select text or images to be printed on each panel 11-18 based on the way in which that panel will be represented in the fold-a-book 20, as shown in FIG. 15, which is produced using the method according to the instant invention. In addition, the user can select text or image(s) to be printed on the front of sheet 10. Based on those preferences, the software can upload or import text or images of the user's selection into the templates for the front and back of sheet 10, using means known in the art, size and orient them properly, and place them into the desired location on the templates. The text or images thus inserted into the template can then be printed on the front and back of sheet 10 as set forth in the template using methods known in the art.

The present invention also contemplates a computer-based interactive system that enables users to create a custom fold-a-book 20 by importing/choosing photos or other content online or through a mobile application, and then auto position them in a web-to-print scenario.

After text and images are printed on the front and back of sheet 10 as described above, a cut 30 will be made through sheet 10 using means known in the art, as shown in FIGS. 2-4. FIG. 4 shows the front of sheet 10 wherein the two halves of sheet 10 have been separated along the cut to expose the cut 30 for purposes of illustration. The cut 30 will be made by making a single transverse incision in sheet 10 along the juncture of panels 12, 13 and panels 16, 17. Cut 30 is depicted as a thick line in FIG. 3. Cut 30 may be made by any conventional paper cutting machine such as a die cutter, timed slitter, or digitally-controlled laser cutting system in which a variable-intensity laser beam capable of high speed movement is used to cut material. Such cutting machines typically include a cutting bed upon which the paper 10 is placed and having an X-Y plotter with articulating laser head thereon or a rastering laser that directs the laser beam by driving mirrors to direct the beam on the bed.

After cut 30 is made, sheet 10 may be scored for folding. In some situations, the sheet may be scored and die cut or slit in a single pass. In the preferred embodiment of the present invention, sheet 10 may be scored using an automated scoring machine or attachment to achieve straight, permanent folds with minimal damage to the text or images that are printed on sheet 10. In another embodiment of the present invention, scores or creases for use in folding can be made using any method known in the art, including the method of folding and pressing sheet 10 along its fold, which can be achieved by the user by hand. The terms score and crease are used herein interchangeably, and it is preferred that each score, crease and fold discussed herein has less fold-resistance than uncreased, unscored, or unfolded material but also has enough strength to be folded and unfolded numerous times with minimal or reduced tearing. In addition, the terms “top”, “bottom”, “left”, “right”, “right hand”, etc. as used herein are not intended to limit the invention but are used to aid in depicting the method according to the present invention wherein the directional words listed above correspond to the directions on the page containing the figures herein.

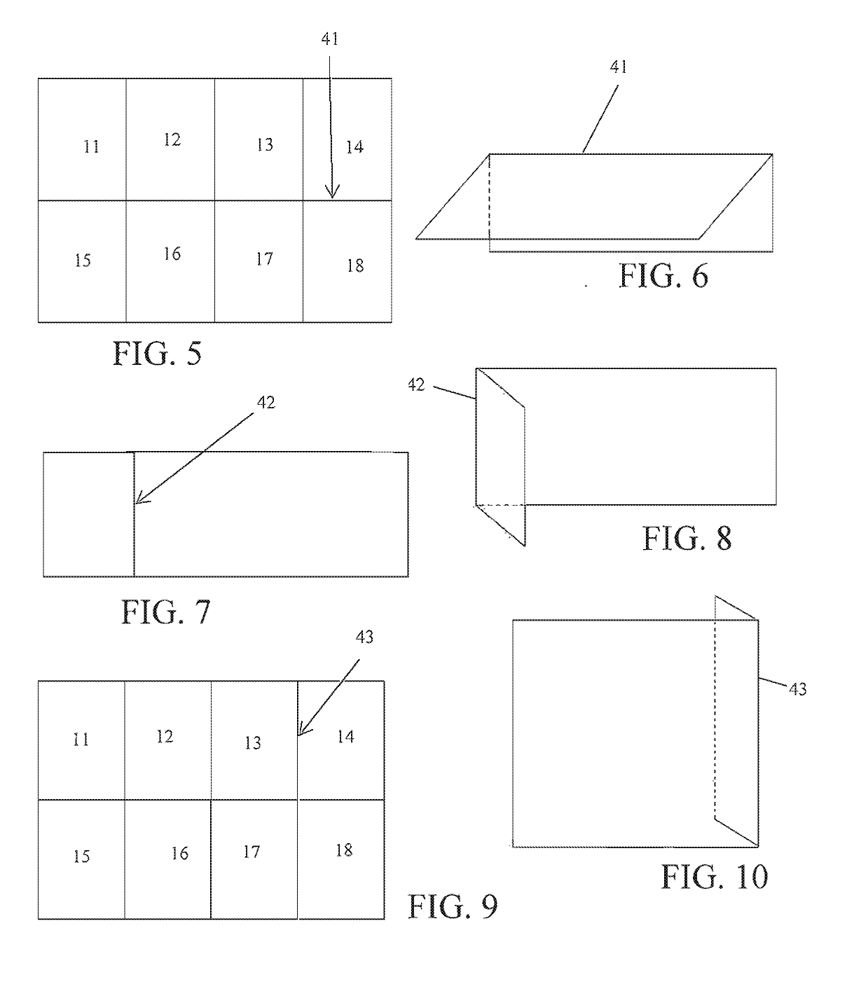

For the method of folding and pressing sheet 10 by hand, and with reference to FIG. 5, a transverse first crease 41 is made on sheet 10 dividing it in half along its width W. As shown in FIG. 6, with the back of sheet 10 facing forward, crease 41 is made by folding sheet 10 in half inwardly along its width W along the line separating panels 11, 12, 13 and 14 from panels 15, 16, 17 and 18. The fold is made such that the bottom half of sheet 10 remains stationary and the top half of sheet 10 is moved in a downward manner towards the bottom half of sheet 10 and closed along crease 41 so that the top and bottom halves of sheet 10 are in inwardly facing direct contact with each other.

As shown in FIG. 7, with sheet 10 in a folded position along crease 41 as set forth above, a second transverse crease 42 is made in sheet 10 ¼ of the way down the width of sheet 10 from the left (wherein “left” indicates the left hand side of the figures). FIG. 8 shows the method of creating crease 42, wherein the leftmost quarter of folded sheet 10, to the left of crease 41, is folded inward such that the right hand ¾ of sheet 10, to the right of crease 41, remains stationary and the left ¼ of sheet 10 is moved towards the right and inwards and closes along crease 42 such that the right and left portions of sheet 10 are in inwardly facing direct contact with each other. Because crease 42 is made on sheet 10 while sheet 10 is already folded along crease 41, crease 10 is formed into both the top and bottom halves of sheet 10. Crease 42 is formed along the line dividing panels 11 and 15 from panels 12 and 16. However, panels 11, 12, 15 and 16 are not visible during the process of making crease 42 because sheet 10 is folded inwardly from the back along crease 41, as set forth above, during the process of forming crease 42.

After forming creases 41 and 42, sheet 10 may be unfolded, with the back of sheet 10 facing up out of the page, in order to create creases 43 and 44. As shown in FIG. 9, transverse crease 43 is made along the height H of sheet 10 ¾ of the way across sheet 10 from the left hand side. Specifically, as shown in FIG. 9, crease 43 is made along the line dividing panels 13 and 17 from panels 14 and 18. FIG. 10 shows the process of creating crease 43, wherein the left hand portion of sheet 10, to the left of crease 43, remains stationary, and the right ¼ of sheet 10, to the right of crease 43, is moved towards the left and backwards behind sheet 10 such that front portion of sheet 10 corresponding to panels 14 and 18 is in direct contact with the remainder of the front of sheet 10.

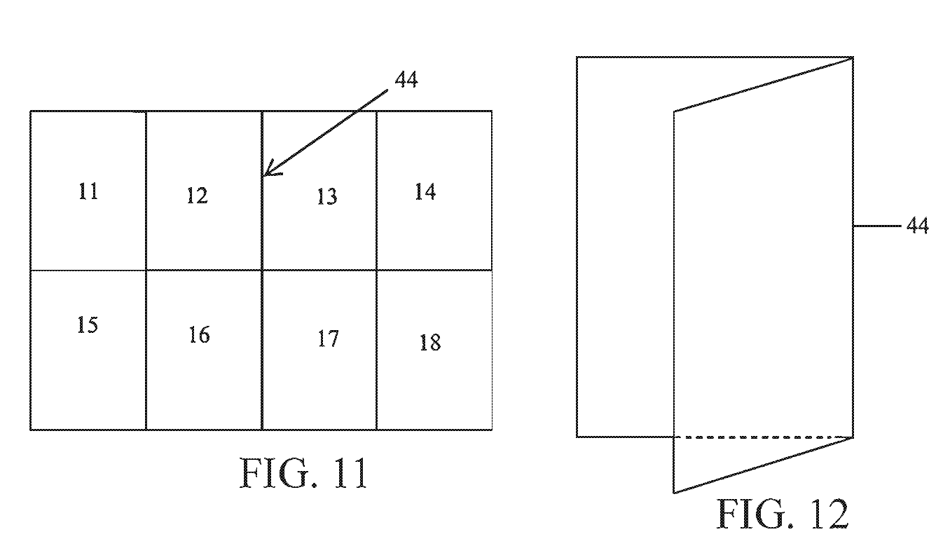

After forming crease 43, sheet 10 is unfolded with the back of sheet 10 facing up out of the page. Then, as shown in FIG. 11, transverse crease 44 is made by folding sheet 10 in half inwardly along its height H, or along a line dividing panels 12 and 16 from panels 13 and 17. As shown in FIG. 12, the left half of sheet 10, to the left of crease 44, remains stationary while the right half of sheet 10, to the right of crease 44, is moved to the left and inward towards the left half of sheet 10 such that the left and right halves of sheet 10 are in inwardly facing direct contact with each other. Sheet 10 may then be unfolded completely.

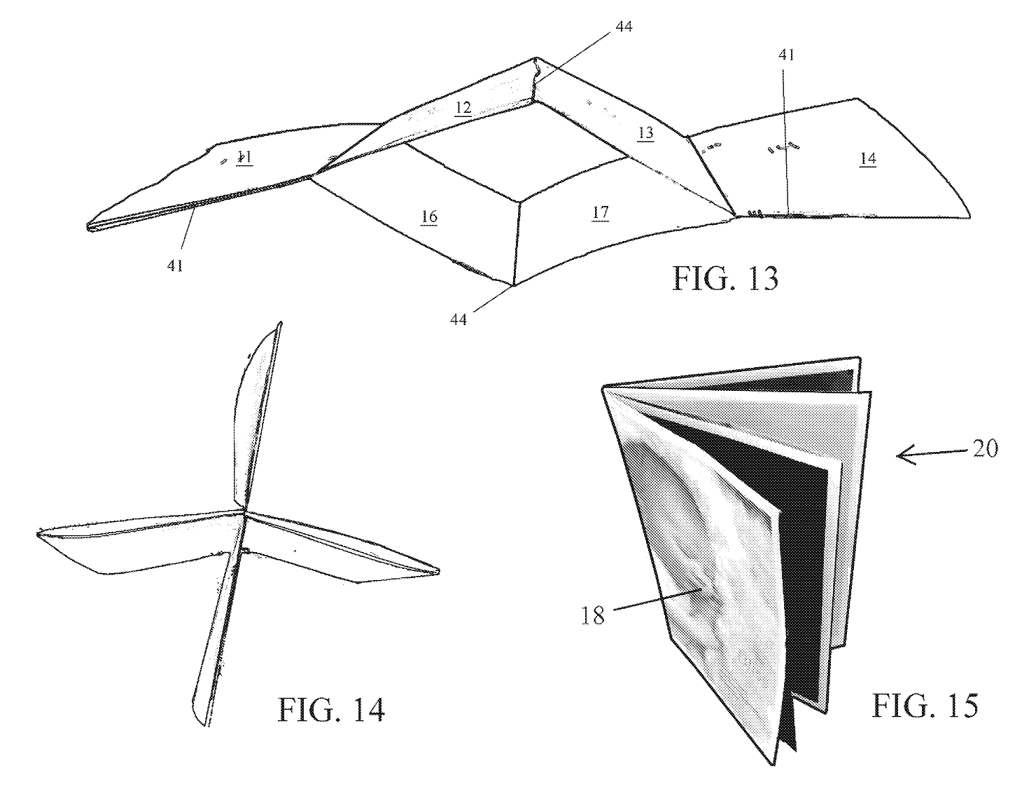

As shown in FIG. 13, fold-a-book 20 may then be formed manually by folding sheet 10 along crease 41, such that the depicted content of panels 11, 12, 13, and 14 appears upside down to the viewer, while ensuring that panels 12, 13 fold outward along crease 44 and panels 16, 17 fold inward. Cut 30 can then be opened to allow this, effectively forming a diamond cross-sectional shape of panels 12, 13, 16, and 17. The ends of the folded sheet 10 (FIG. 13) are moved together, effectively bifolding panels 12, 13 above the incision and bifolding panels 16, 17 below the incision. Continuing this fold to its extreme results in panels 11, 15, 14 and 18 being pushed together so that lines 42 and 43 are joined, thereby defining four bifold pages extending radially along a spline, creating a pinwheel effect, as seen in FIG. 14.

To create the finished fold-a-book 20 shown in FIG. 15, panel 17 is placed on top of Panel 15 and Panel 18 is placed on top of Panel 13, thereby folding four bifold pages together about the spline to make the folded booklet.

At this juncture, Panels 17 and 18 are visible on top and Panels 11 and 12 are visible on the backside. Panels 17 and 18 are then brought together where Panel 18 is the beginning of the folded book and Panel 17 is considered the back of fold-a-book 20.

The above-described folding method explains how fold-a-book 20 can be manually folded by hand. However when folded by machine, the process steps will be sequenced differently due to machine constraints. Machine slitting and folding requires proper equipment such as, for example, a folding machine of the Stahlfolder™ TH/KH series from Heidelberg™ equipped with an optional EAP head for timed slitting and perforation. Initially, and with reference to FIG. 3 the EAP head would create a timed slit 30 between panels 12, 16 and 13, 17. The sheet is then fed to the buckle-plate folder to perform a parallel fold. With reference to FIGS. 7-8, a first parallel fold is formed between panels 11, 15 and 12, 16 along crease 42 so that the top and bottom halves of sheet 10 are in inwardly facing direct contact with each other. An opposite second parallel is formed between panels 12, 13 and 16, 17 effectively inverting the first fold. As per FIG. 5, with sheet 10 still in the above-folded position, a third fold is made along crease 41 between the top and bottom halves of sheet 10. Finally, a fourth transverse fold 43 is made in sheet as seen in FIG. 9 to finish.

As shown in FIG. 15, panel 18 forms the front cover of fold-a-book 20, and the remainder of panels 11-17 form pages in the fold-a-book and the back cover, containing images as set forth in the template prior to printing sheet 10. Fold-a-book 20 may be sized so that individual panels may be removed for display in a standard size photo frame. In addition, fold-a-book 20 may be unfolded completely to expose the large image printed on the front of sheet 10, which is not visible to the user while fold-a-book 20 is in its completely folded position. The template used to create fold-a-book 20 may further be designed to print text on various parts of fold-a-book 20 to instruct the user on how to unfold and/or remove portions of fold-a-book 20 for use in display or framing, and may specify the size of picture frame that portions of fold-a-book 20 or sheet 10 will fit into.

In this way, a booklet type image conveyance is created using folding techniques alone without the need for costly staples or other fastening mechanisms. Moreover, the booklet made according to the method herein may easily be unfolded to display a large image that is eight times larger than the folded booklet for display as a poster or the like.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

I claim:

1. A method of making a folded booklet by cutting and folding a rectangular sheet having a length l and a width w, where l≧w, comprising the steps of:
forming an incision through the sheet along a lengthwise centerline of said sheet, a length of said incision being approximately one half the length l;
creasing said sheet multiple times to define eight distinct panels arrayed in a four-by-two array;
folding said sheet in half along said centerline;
moving the ends of said folded sheet together to bifold a first pair of said panels above said incision and to bifold a second pair of said panels below said incision, thereby defining four bifold pages extending radially along an axis;
folding said four bifold pages together about said axis to make said folded booklet.

2. The method for making the folded booklet according to claim 1, wherein said step of creasing said sheet multiple times to define eight distinct panels further comprises the substeps of:
folding said sheet along a widthwise centerline to define a first widthwise crease in said sheet along said widthwise center line and unfolding said sheet,
folding said sheet along said lengthwise centerline to define a second lengthwise crease in said sheet along said lengthwise centerline,
while still folded lengthwise, folding the opposing ends of said folded sheet inward and together at said first widthwise crease, and
unfolding said folded sheet to define said eight distinct panels arrayed in a four-by-two array.

3. The method for making the folded booklet according to claim 1, further comprising a step of printing text and images on the front and back of said sheet.

4. A method for making a fold-a-book folded booklet product from a single rectangular sheet of paper, comprising the steps of:
obtaining a rectangular sheet of paper capable of being divided into eight uniform rectangular panels P1-P8 arrayed in a four-by-two array where panels P1-P4 are aligned contiguously above corresponding panels P5-P8;
printing text and images on the front and back of said sheet;
making a single cut through said sheet that extends from a juncture of panels P1, P2, P5 and P6 to a juncture of panels P3, P4, P7 and P8;
creasing said sheet a first time lengthwise by folding along a centerline between panels P1-P4 and panels P5-P8;
while said sheet remains folded per said first folding step, creasing said sheet a second time by folding transversely such that panels P1 and P5 are folded over panels P2 and P6;
unfolding said sheet;
creasing said sheet a third time by folding along a line running between panels P3-P4 and panels P7-P8 such that panels P4 and P8 are folded behind panels P3 and P7;
unfolding said sheet;
reversing said sheet;
creasing said sheet a fourth time by folding from top to bottom along a centerline running between panels P2-P3 and panels P6-P7;
unfolding said sheet;
forming said fold-a-book by folding said sheet along all of said first through fourth creases formed by the preceding steps.

5. The method according to claim 4, further comprising the initial step of:
determining an individual rectangular panel size for said eight uniform panels P1-P8 of said folded booklet, including panel height Hₚ and panel width Wₚ; and
wherein said step of obtaining a rectangular sheet of paper comprises obtaining a sheet of height Hₛ and sheet width Wₛ, where Hₛ=Hₚ*2 and Wₛ=Wₚ*4.

6. The method according to claim 4, further comprising the initial steps of:
obtaining a rectangular sheet of paper of sheet height Hₛ and sheet width Wₛ; and
calculating an individual rectangular panel size for all uniform pages of said folded booklet, including panel height Hₚ and panel width Wₚ, by the formulae Hₚ=Hₛ/2 sand Wₚ=Wₛ/4.

7. The method according to claim 6, further comprising the initial steps of:
obtaining a 12×18″ press sheet; and
trimming said press sheet down to a size of 12×16″ by removing 2 inches from its width;
whereby said panels P1-P8 have a panel height Hₚ of 4″ and a panel width Wₚ of 6″.

8. The method according to claim 6, further comprising the initial steps of:
obtaining a 20.8125×29.5″ sheet;
whereby said panels P1-P8 have a panel height Hₚ of 5″ and a panel width Wₚ of 7″, and said fold-a-book fits into a standard A-7 envelope.

9. A method for making a fold-a-book folded booklet product from a single rectangular sheet of paper, comprising the steps of:
obtaining a rectangular sheet of paper;
dividing said sheet of paper into eight uniform rectangular panels P1-P8, where panels P1-P4 are aligned contiguously above corresponding panels P5-P8;
printing text and images on the front and back of said sheet;
making a single cut through said sheet that extends from a juncture of panels P1, P2, P5 and P6 to a juncture of panels P3, P4, P7 and P8;
creasing said sheet a first time by folding along a line running between panels P1 and P2 and panels P5 and P6;
creasing said sheet a second time by folding opposite said first crease along a line running between panels P2 and P6 and panels P3 and P7;
while said sheet remains folded per said first and second folding steps, creasing said sheet a third time by folding lengthwise along a centerline between panels P1-P4 and panels P5-P8;
unfolding said sheet;
creasing said sheet a fourth time by folding from top to bottom along a line running between panels P3-P4 and panels P7-P8;
unfolding said sheet;
forming said fold-a-book by folding said sheet along all of said first through fourth creases formed by the preceding steps.

10. The method according to claim 9, further comprising the initial steps of:
determining an individual rectangular panel size for eight uniform panels P1-P8 of said folded booklet, including panel height Hₚ and panel width Wₚ, where panels P1-P4 are aligned contiguously above corresponding panels P5-P8; and
obtaining a rectangular sheet of paper of sheet height Hₛ and sheet width Wₛ obtaining a rectangular sheet of paper of overall sheet height Hₛ and sheet width Wₛ, where Hₛ=Hₚ*2 and Wₛ=Wₚ*4.

11. The method according to claim 9, further comprising the initial steps of:
obtaining a rectangular sheet of paper of sheet height Hₛ and sheet width Wₛ; and
calculating an individual rectangular panel size for all uniform pages of said folded booklet, including panel height Hₚ and panel width Wₚ, by the formulae Hₚ=Hₛ/2 and Wₚ=Wₛ/4.

12. The method according to claim 9, further comprising the initial steps of:
obtaining a 12×18″ press sheet; and
trimming said press sheet down to a size of 12×16″ by removing 2 inches from its width;
whereby said panels P1-P8 have a panel height Hₚ of 4″ and a panel width Wₚ of 6″.

13. The method according to claim 9, further comprising the initial steps of:
obtaining a 20.8125×29.5″ sheet;
whereby said panels P1-P8 have a panel height Hₚ of 5″ and a panel width Wₚ of 7″, and said fold-a-book fits into a standard A-7 envelope.

14. A fold-a-book folded booklet product comprising eight uniform rectangular panels P1-P8 arranged and printed on front and back of four pages joined along a common spline, said fold-a-book being formed from a single rectangular sheet of paper in accordance with the steps of:
obtaining a rectangular sheet of paper;
dividing said sheet of paper into eight uniform rectangular panels P1-P8, where panels P1-P4 are aligned contiguously above corresponding panels P5-P8;
printing text and images on the front and back of said sheet;
making a single cut through said sheet that extends from a juncture of panels P1, P2, P5 and P6 to a juncture of panels P3, P4, P7 and P8;
creasing said sheet a first time lengthwise by folding along a centerline between panels P1-P4 and panels P5-P8;
while said sheet remains folded per said first folding step, creasing said sheet a second time by folding transversely such that panels P1 and P5 are folded over panels P2 and P6;
unfolding said sheet;
creasing said sheet a third time by folding along a line running between panels P3-P4 and panels P7-P8 such that panels P4 and P8 are folded behind panels P3 and P7;
unfolding said sheet;
reversing said sheet;
creasing said sheet a fourth time by folding from top to bottom along a centerline running between panels P2-P3 and panels P6-P7;
unfolding said sheet;
forming said fold-a-book by folding said sheet along all of said first through fourth creases formed by the preceding steps.

15. A fold-a-book folded booklet product comprising eight uniform rectangular panels P1-P8 arranged and printed on front and back of four pages joined along a common spline, said fold-a-book being formed from a single rectangular sheet of paper in accordance with the steps of:
obtaining a rectangular sheet of paper;
dividing said sheet of paper into eight uniform rectangular panels P1-P8, where panels P1-P4 are aligned contiguously above corresponding panels P5-P8;
printing text and images on the front and back of said sheet;
making a single cut through said sheet that extends from a juncture of panels P1, P2, P5 and P6 to a juncture of panels P3, P4, P7 and P8;
creasing said sheet a first time by folding along a line running between panels P1 and P2 and panels P5 and P6;
creasing said sheet a second time by folding opposite said first crease along a line running between panels P2 and P6 and panels P3 and P7;
while said sheet remains folded per said first and second folding steps, creasing said sheet a third time by folding lengthwise along a centerline between panels P1-P4 and panels P5-P8;
unfolding said sheet;
creasing said sheet a fourth time by folding from top to bottom along a line running between panels P3-P4 and panels P7-P8;
unfolding said sheet;
forming said fold-a-book by folding said sheet along all of said first through fourth creases formed by the preceding steps.
